(19) United States
(12) Patent Application Publication
(10) Pub. No.: US 2010/0329709 A1
(43) Pub. Date: Dec. 30, 2010

(54) IMAGE FORMING APPARATUS

(75) Inventors: Takashi OCHI, Ebina-shi (JP); Shinichi KURAMOTO, Ebina-shi (JP); Shinichiro FUJIMORI, Ebina-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/618,214

(22) Filed: Nov. 13, 2009

(30) Foreign Application Priority Data
Jun. 25, 2009 (JP) P. 2009-150765

(51) Int. Cl. G03G 15/06; G03G 15/16

(52) U.S. Cl. 399/49; 399/55; 399/66

(57) ABSTRACT

An image forming apparatus includes an image carrier; a charging device that charges a surface of the image carrier; an exposure device that forms an electrostatic latent image on the charged surface of the image carrier; a developing device that forms a toner image by transferring toner to the electrostatic latent image from a developing member opposed to the image carrier; and a transfer device that either directly transfers the toner image onto a recording medium or transfers the toner image onto a recording medium after the toner image is temporarily transferred onto an intermediate transfer member.

### CROSS-REFERENCE TO RELATED APPLICATIONS

This application is based on and claims priority under 35 USC 119 from Japanese Patent Application No. 2009-150765 filed Jun. 25, 2009.

### BACKGROUND

1. Technical Field

The present invention relates to an image forming apparatus for forming a toner image by transferring toner to a latent image formed on the basis of an electrostatic potential difference.

2. Related Art

The image forming apparatus, configured to form a visible image by attachment of toner, is widely adopted as a copier, a facsimile machine, a printer and the like. Such an image forming apparatus is configured to form an image fixed +on a recording sheet, for instance, by executing the steps of: approximately uniformly electrifying an image carrier that includes a photosensitive layer; forming an electrostatic latent image by causing an exposure device to irradiate the surface of the image carrier with image light; forming a toner image by causing a developing device to transfer toner to the latent image; and transferring the toner image within an electric field that is formed by the application of a transfer bias voltage.

To form an image with proper toner density, most of image forming apparatuses as described above control a variety of image forming conditions including the electrification amount of an image carrier, the exposure amount of an exposure device and a developing bias voltage to be applied to the developing device. With this configuration, an image can be formed by the proper regulation of the toner density or the like, even when developing efficiency varies due to environmental changes in an installation site of the image forming apparatus and the like.

### SUMMARY

According to an aspect of the present invention, there is provided an image forming apparatus, including: an image carrier; a charging device that charges a surface of the image carrier; an exposure device that forms an electrostatic latent image on the charged surface of the image carrier; a developing device that forms a toner image by transferring toner to the electrostatic latent image from a developing member opposed to the image carrier; and a transfer device that either directly transfers the toner image onto a recording medium or transfers the toner image onto a recording medium after the toner image is temporarily transferred onto an intermediate transfer member, wherein absolute value of transfer current or absolute value of a transfer voltage to be applied to the transfer device is changed so as to reduce a transfer efficiency when at least one of a developing voltage, a voltage of background and the amount of electrostatic charges of the toner does not satisfy a reference value, the developing voltage being set as a difference between electric potential of the developing member and electric potential of an image part of the electrostatic latent image formed on the image carrier, and the voltage of background being set as a difference between electric potential of the developing member and electric potential of a non-image part on the image carrier.

### BRIEF DESCRIPTION OF THE DRAWINGS

FIG. 1 is a schematic configuration diagram for illustrating an image forming apparatus of a first exemplary embodiment of the present invention;

FIG. 2 is a diagram for describing development voltage and cleaning voltage in the image forming apparatus illustrated in FIG. 1;

FIG. 3 is a diagram showing the relation between the developing voltage and uneven toner density of a solid image in the image forming apparatus illustrated in FIG. 1;

FIG. 4 is a diagram showing the relation between the cleaning voltage and the grade of fog generated in a non-image part in the image forming apparatus illustrated in FIG. 1;

FIG. 5 is a diagram showing the relation between “a ratio of a development potential to a cleaning potential” and “reproducibility of a thin line” in the image forming apparatus illustrated in FIG. 1;

FIG. 6 is a flowchart illustrating an image density control in the image forming apparatus illustrated in FIG. 1;

FIG. 7 is a flowchart illustrating an image density control in an image forming apparatus of a second exemplary embodiment of the present invention;

FIG. 8 is a flowchart illustrating an image density control in the image forming apparatus of the second exemplary embodiment of the present invention;

FIG. 9 is a flowchart illustrating an image density control in an image forming apparatus of a third exemplary embodiment of the present invention;

FIG. 10 is a schematic configuration diagram illustrating an image forming apparatus of a fourth exemplary embodiment of the present invention; and

FIG. 11 is a flowchart illustrating an image density control in the image forming apparatus of the fourth exemplary embodiment of the present invention.

### DETAILED DESCRIPTION

An exemplary embodiment of the present invention will be hereinafter described with reference to accompanying figures.

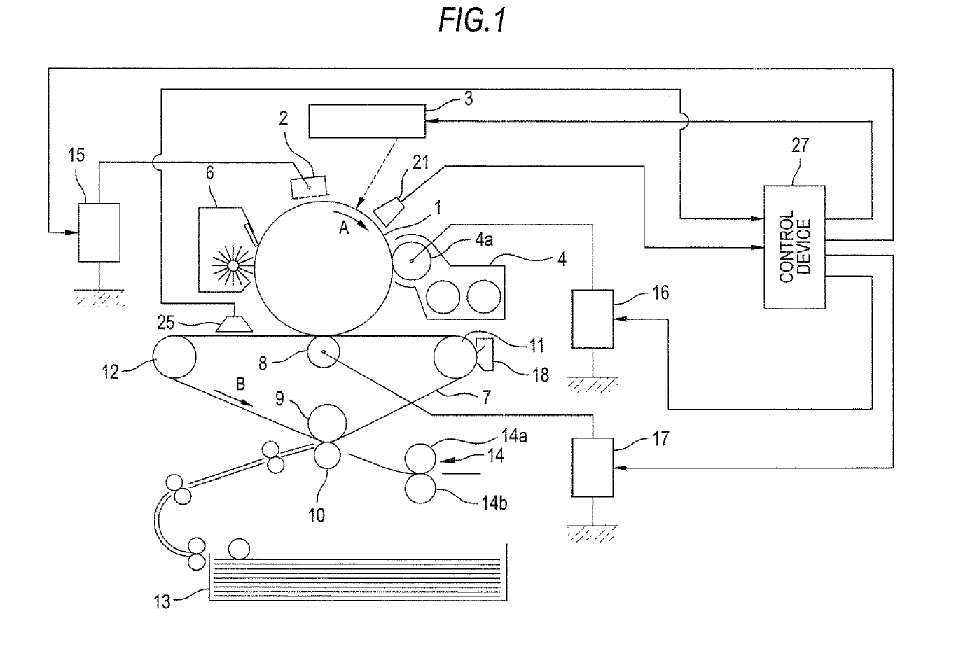

FIG. 1 is a schematic configuration diagram of an image forming apparatus of an exemplary embodiment of the present invention.

The image forming apparatus includes a cylindrical photosensitive drum 1. A latent image is formed on the surface of the photosensitive drum 1 due to an electrostatic potential difference. Furthermore, the image forming apparatus includes the following components around the photosensitive drum 1: a charging device 2; an exposure device 3; a developing device 4; an intermediate transfer belt 7; a primary transfer roll 8; and a cleaning device 6. The charging device 2 uniformly electrifies the surface of the photosensitive drum 1. The exposure device 3 forms a latent image on the surface of the photosensitive drum 1 by irradiating the surface of the photosensitive drum 1 with image light. The developing device 4 forms a toner image by selectively transferring toner to the latent image formed on the photosensitive drum 1. The intermediate transfer belt 7 is an endless belt, which is opposed to the photosensitive drum 1. The intermediate transfer belt 7 is supported so that the circumferential surface thereof can circulate. The primary transfer roll 8 primarily transfers the toner image, which is formed on the photosensitive drum 1, onto the intermediate transfer belt 7. The cleaning device 6 removes toner remaining on the photosensitive drum 1 after the toner image is transferred.

The charging device 2, the developing device 4 and the primary transfer roll 8 are connected to power source devices 15, 16, 17, respectively. Accordingly, voltages and the like to be applied thereto are controlled by a signal that is outputted from a control device 27 as needed.

The intermediate transfer belt 7 is tensively laid among a drive roll 11, a tension roll 12 and a backup roll 9. The drive roll 11 circularly drives the intermediate transfer belt 7 in a direction of an arrow B. The tension roll 12 supports the intermediate transfer belt 7 while urging it in a tensioned condition. The backup roll 9 executes secondary transfer. The intermediate transfer belt 7 is thus configured to be driven in its circumferential direction. A secondary transfer roll 10 is disposed so as to face the backup roll 9 through the intermediate transfer belt 7. The secondary transfer roll 10 transfers the toner image, which is formed on the intermediate transfer belt 7, onto a recording sheet. A recording sheet, transported from a sheet tray 13, is configured to be fed into a contact portion between the intermediate transfer belt 7 and the secondary transfer roll 10.

A fixing device 14 is disposed at the downstream side of the position where the backup roller 9 and the secondary transfer roll 10 face each other. The fixing device 14 pressure-fixes the toner image on the recording sheet by heating and pressurizing the toner image. Furthermore, a sheet discharge tray (not illustrated in the figure) is disposed at the downstream side of the fixing device 14, and it accommodates therein the recording sheet passed through the fixing device 14.

In addition, a surface potential measurement unit 21 is disposed so as to face the photosensitive drum 1. Specifically, the surface potential measurement unit 21 is disposed at the downstream side of an exposure position in a moving direction of the circumferential surface of the photosensitive drum 1. Simultaneously, the surface potential measurement unit 21 is disposed at the upstream side of a position where the developing device 4 faces the photosensitive drum 1. The surface potential measurement unit 21 is configured to measure the surface potential of the exposed photosensitive drum 1, that is, the electric potentials of an exposed part and a non-exposed part of the photosensitive drum 1.

On the other hand, a toner density detection unit 25 is disposed at the downstream side of a position where the primary transfer roll 8 is disposed in the circulation direction of the intermediate transfer belt 7. The toner density detection unit 25 measures toner density of the toner image transferred onto the intermediate transfer belt 7. Then, measurement results of the surface potential measurement unit 21 and the toner density detection unit 25 are inputted into the control device 27.

The configuration of the image forming apparatus will be hereinafter described in detail.

The photosensitive drum 1 is formed by laminating organic photosensitive layers on the circumferential surface of a metal cylindrical member. A metal part of the photosensitive drum 1 is electrically grounded. A bias voltage may be applied to the photosensitive drum 1. The photosensitive drum 1 is rotationally driven about a central axis. Accordingly, the circumferential surface of the photosensitive drum 1 is configured to circulate in a direction of an arrow A illustrated in FIG. 1.

The charging device 2 is provided with an electrode wire. The electrode wire is stretched at a predetermined distance from the circumferential surface of the photosensitive drum to be electrified. The power source device 15 for electrification applies a voltage between the electrode wire and the photosensitive drum 1. Accordingly, a corona discharge occurs and the surface of the photosensitive drum 1 is electrified. The control device 27 causes the electrification power source device 15 to adjust a voltage that is applied to the electrode wire. Accordingly, the power source device 15 can adjust an electrification potential on the surface of the photosensitive drum 1.

As described above, a device for electrifying the photosensitive drum 1 with the corona discharge is used in this exemplary embodiment. However, a solid discharger or a contact/non-contact charging device of a roll or blade type may be used as the charging device.

The exposure device 3 outputs a blinking laser beam on a pixel-by-pixel basis on the basis of an image signal. The exposure device 3 also performs a scan exposure of the circumferential surface of the photosensitive drum 1 with a polygon mirror. Accordingly, an electric potential is attenuated in the exposed part on the circumferential surface of the photosensitive drum 1, and a latent image is formed due to an electrostatic potential difference. Intensity of the laser beam outputted from the exposure device 3 is controlled by a signal from the control device 27. The attenuation amount of the electric potential is accordingly adjusted in the exposed part.

The developing device 4 uses a two-component developer composed of toner and magnetic carrier. The developing device 4 includes a developing roll 4a as a developing member in an adjacent position to the photosensitive drum 1. A thin layer of the two-component developer is formed on the circumferential surface of the developing roll 4a. When the developing roll 4a rotates, developer on its circumferential surface is transported to a developing area opposed to the photosensitive drum 1. Furthermore, a member for agitating developer is disposed inside the developing device 4. The agitation member agitates toner and magnetic carrier at the inside of the developing device 4. Accordingly, toner is frictionally electrified to the same polarity (i.e., negative (−) polarity) as the electrification polarity of the surface of the photosensitive drum 1.

The power source device 16 for development applies a developing bias voltage between the developing roll 4a and the photosensitive drum 1. When an electrostatic latent image formed on the photosensitive drum 1 passes through a position opposed to the developing roll 4a, toner is electrostatically transferred to the exposed part. Thus, an electrostatic latent image is developed. The control device 27 can adjust the electric potential to be applied to the developing roll 4a. The amount of toner to transfer to the electrostatic latent image can be accordingly adjusted.

The two-component developer is used in the exemplary embodiment of the present invention. However, a mono-component developer may be used.

The primary transfer roll 8 is formed by covering the outer circumferential surface of a metal core member with electrically conductive rubber material. The primary transfer roll 8 is disposed at a position where the photosensitive drum 1 and the intermediate transfer belt 7 are opposed to each other at the back side of the intermediate transfer belt 7. The power source device 17 for transfer bias applies a transfer bias voltage between the photosensitive drum 1 and the primary transfer roll 8. When the intermediate transfer belt 7 passes through a position where the primary transfer roll 8 and the photosensitive drum 1 are opposed to each other, the toner image formed on the photosensitive drum 1 is electrostatically transferred onto the intermediate transfer belt 7. The control device 27 controls the transfer bias voltage to be applied by the transfer-bias power source device 17. Transfer efficiency can be accordingly changed.

The cleaning device 6 includes a cleaning brush and a cleaning blade which are disposed in contact with the circumferential surface of the photosensitive drum 1. The cleaning device 6 removes toner remaining on the photosensitive drum 1 after the toner image is transferred from the photosensitive drum 1.

The intermediate transfer belt 7 is formed by dispersing suitable material (e.g., carbon and ion conductive material) into resin material (e.g., polyimide, polyamidimide, polycarbonate and fluororesin) for bringing conductivity to thereby adjust the surface electric resistivity of the intermediate transfer belt 7. In conjunction with rotational driving of the drive roll 11, the intermediate transfer belt 7 circulates in the direction of the arrow B illustrated in FIG. 1. The toner image on the intermediate transfer belt 7, which is transferred from the photosensitive drum 1, is accordingly transported to a position opposed to the secondary transfer roll 10.

A secondary transfer bias voltage is applied between the backup roll 9 and the secondary transfer roll 10. When a recording sheet to be transported from the sheet tray 13 is interposed between the secondary transfer roll 10 and the intermediate transfer belt 7, the secondary transfer roll 10 transfers the toner image, which is formed on the intermediate transfer belt 7, onto the recording sheet by means of the electrostatic force.

A toner removal device 18 is disposed in a position opposed to the drive roll 11 through the intermediate transfer belt 7. The toner removal device 18 comes into contact with the intermediate transfer belt 7, and removes toner remaining on the intermediate transfer belt 7 after the intermediate transfer belt 7 passes through a position opposed to the secondary transfer roll 10.

The fixing device 14 is equipped with a heat roll 14a containing a heat source therein, and a pressure roll 14b. The pressure roll 14b is disposed in parallel to the heat roll 14a. The heat roll 14a and the pressure roll 14b are brought into contact with each other under pressure, thereby forming a nip. A recording sheet is sent to the nip after the toner is transferred thereon. The recording sheet is heated and pressurized between the rotationally-driven heat and pressure rolls 14a, 14b. Accordingly, the toner is pressure-fixed onto the recording sheet.

The surface potential measurement unit 21 is an electric potential sensor for measuring the electric potential on the surface of the photosensitive drum 1. The surface potential measurement unit 21 measures the electric potential under a state that an electrostatic latent image is formed on the surface of the photosensitive drum 1 through irradiation of image light after the surface of the photosensitive drum is uniformly electrified. The surface potential measurement unit 21 measures the electric potential of the exposed part (i.e., an area of the photosensitive drum 1 to which image light is applied) and the electric potential of the non-exposed part (i.e., an area of the photosensitive drum 1 to which image light is not applied). The surface potential measurement unit 21 then inputs a measurement result into the control device 27.

In this exemplary embodiment, a vibration capacitance type electric potential sensor which is opposed to the photosensitive drum 1 without coming into contact with it is used as the surface potential measurement unit 21. However, any suitable sensor may be used as the surface potential measurement unit 21.

The toner density detection unit 25 is a sensor for detecting the density of a toner image transferred onto the intermediate transfer belt 7 after the primary transfer. For example, a TMA (transferred mass per area) sensor may be used as the toner density detection unit 25. A result of detection by the toner density detection unit 25 is also inputted to the control device 27.

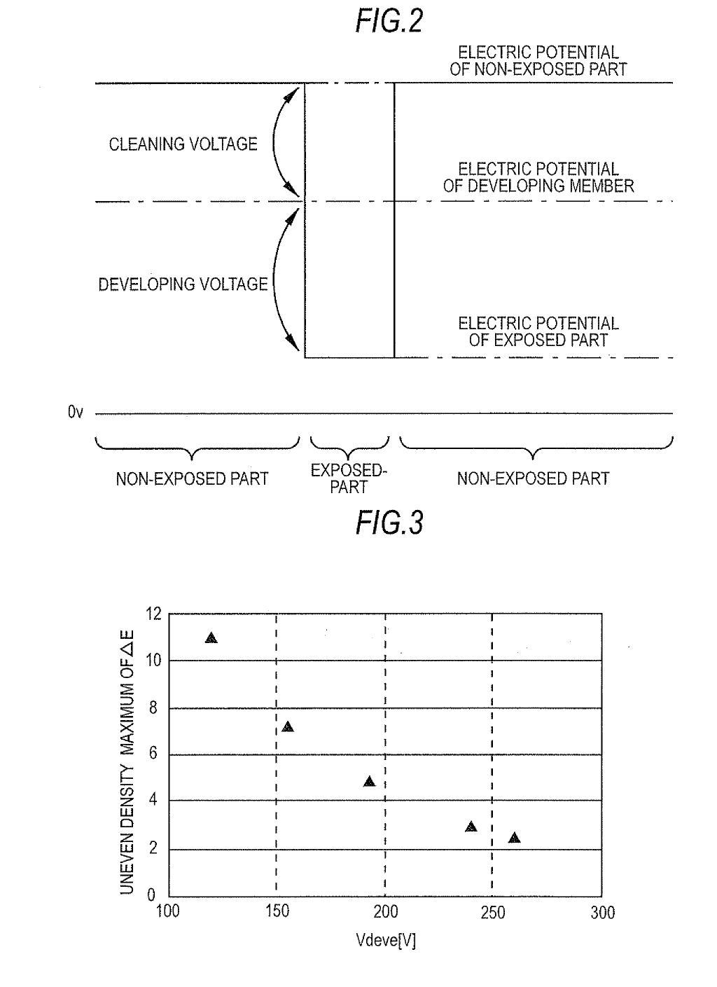

The control device 27 controls the operations of the respective units of the image forming apparatus. Additionally, detection signals are inputted to the control device 27 from the surface potential measurement unit 21 and the toner density detection unit 25. Based on the detection results, the control device 27 adjusts image forming conditions such as the electrification potential on the surface of the photosensitive drum 1 electrified by the charging device 2, the exposure amount (exposure intensity) by the exposure device 3, and the electric potential to be applied to the developing roll 4a. In other words, the control device 27 adjusts the electric potentials of the exposed part and the non-exposed part on the surface of the photosensitive drum 1, and an electric potential of the developing roll 4a for transferring the toner, as illustrated in FIG. 2. The control device 27 also adjusts a transfer bias voltage to be applied to the primary transfer roll 8. Transfer efficiency can be accordingly increased or reduced.

When the electric potential to be applied to the electrode wire of the charging device 2 is set to a high value, the electrification potential on the surface of the photosensitive drum 1 increases and the electric potential of the non-exposed part increases in the developing step. In addition, when the exposure amount by the exposure device 3 is increased, the attenuation amount of the electric potential on the surface of the photosensitive drum 1 is increased and thus the electric potential of the exposed part is reduced. Furthermore, the developing voltage and the cleaning voltage can be adjusted by changing the electric potential to be applied to the developing roll 4a.

As illustrated in FIG. 2, the developing voltage corresponds to the difference between the electric potential of the exposed part of the photosensitive drum 1 and the electric potential applied to the developing roll 4a. In other words, the developing voltage corresponds to a developing bias voltage for generating electric field that transfers the toner onto the photosensitive drum 1. On the other hand, the cleaning voltage corresponds to the difference between the electric potential of the non-exposed part of the photosensitive drum 1 and the electric potential of the developing roll 4a. In other words, the cleaning voltage corresponds to a voltage for transferring the toner existing on the non-exposed part of the photosensitive drum 1 toward the developing roll 4a.

The control of the image forming condition described above will be described in detail later.

According to the image forming apparatus, an image is formed by the following operation.

When a series of image forming operations is started, the photosensitive drum 1 and the intermediate transfer belt 7 are rotationally driven. The charging device 2 approximately uniformly electrifies the surface of each photosensitive drum 1 at an electric potential of about −800V to −600V. Then, a blinking laser beam is outputted based on the image data, and the photosensitive layer of the surface of the photosensitive drum 1 is scanned with the blinking laser beam. Accordingly, the electric potential is attenuated at an irradiation position of the laser beam, and a latent image is formed on the surface of the photosensitive drum 1 due to an electrostatic potential difference.

The electrostatic latent image formed on the photosensitive drum 1 is transported to a developing position opposed to the developing roll 4a in conjunction with the rotation of the photosensitive drum 1. When the electrostatic latent image passes through the developing position, the toner attached to the developing roll 4a electrostatically transfers to the exposed part of the surface of the photosensitive drum

1. Accordingly, a toner image is developed.

In the primary transfer section, the photosensitive drum 1 and the primary transfer roll 8 are opposed to each other through the intermediate transfer belt 7. A transfer bias voltage is applied between the photosensitive drum 1 and the primary transfer roll 8. The toner image developed on the surface of each photosensitive drum 1 is transferred onto the surface of the intermediate transfer belt 7 within an electric field formed between the photosensitive drum 1 and the primary transfer roll 8. The transfer bias voltage applied to the primary transfer roll 8 has an opposite polarity (+) to a polarity of the toner (−). For example, the transfer bias voltage is controlled under a constant current of roughly +20 to 30 μA.

The toner image transferred onto the intermediate transfer belt 7 is transported to a position opposed to the secondary transfer roll 10 in the direction of the arrow B illustrated in FIG. 1. A recording sheet is transported between the secondary transfer roll 10 and the intermediate transfer belt 7 at a predetermined timing. A secondary transfer bias voltage is applied between the secondary transfer roll 10 and the backup roll 9. The transfer bias voltage applied to the secondary transfer roll 10 has the opposite polarity (+) to the toner polarity (−). The electrostatic force acts on the toner within the formed electric field. The toner image on the surface of the intermediate transfer belt 7 is accordingly transferred onto the recording sheet.

Subsequently, the recording sheet is sent to the fixing device 14 in which the toner image is heated and pressurized. The toner image is accordingly fixed on the surface of the recording sheet.

When the image is thus fixed on the recording sheet, the recording sheet is transported to the discharge section. The series of image forming operations is thus completed.

The image forming apparatus is configured to adjust the image forming conditions before the aforementioned image formation is started or every time the image formation is performed for a single or plurality of predetermined sheets of paper.

The density of an image formed by the image forming apparatus varies in accordance with environmental changes, a change of the electrification amount of toner, etc. In order to form a fine image constantly, the image forming conditions such as the electrification potential on the surface of the photosensitive drum, the electric potential of the exposed part, and the electric potential of the developing roll 4a are controlled based on a signal from the control device 27.

Following is the relation between an image condition and both of the developing voltage and the cleaning voltage, which are adjusted by the controls of the electrification potential on the surface of the photosensitive drum 1, the electric potential of the exposed part and the electric potential of the developing roll 4a.

When the developing voltage is reduced, the density of the developed image is reduced. On the other hand, when the developing voltage is increased, the density of the image is increased. The image density depends on the amount of toner transferred until the toner stops transferring to the exposed part as a result of more reducing the intensity of the electric field generated between the developing roll 4a and the photosensitive drum 1 as the charged toner transfers to the exposed part. Therefore, when the developing voltage is high, the amount of transferred toner is increased.

On the other hand, when the developing voltage is reduced, uneven density easily occurs in a solid image, that is, an image in which toner is transferred to 100% of the pixel area thereof.

FIG. 3 is a diagram showing an experimental result of studying the relation between the developing voltage and the uneven toner density within the area of the solid image.

As illustrated in FIG. 3, when the developing voltage is reduced, the uneven toner density easily occurs within the area of the solid image. This shows that an image having a proper toner density can not be formed. Therefore, a reference value (i.e., lower limit) of the developing voltage is desirably set within a range in which the uneven toner density does not occur.

On the other hand, when the cleaning voltage is reduced, fog easily occurs. Fog is a phenomenon that toner slightly transfers to a non-image part in which a toner image is not originally developed.

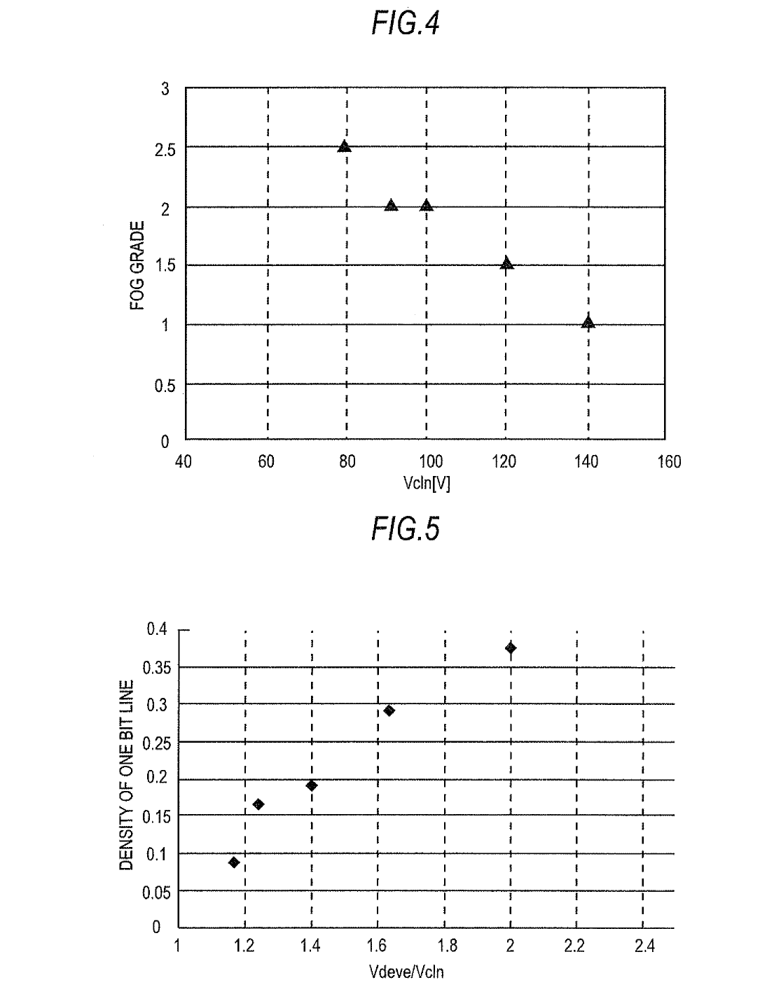

FIG. 4 shows a result of an experiment for studying the relation between the cleaning voltage and occurrence conditions of fog.

As shown in FIG. 4, when the cleaning voltage is reduced, fog grade is increased and an image is deteriorated.

Reproducibility of a thin line is influenced by the ratio of the developing voltage to the cleaning voltage. When the ratio is reduced, reproducibility is reduced. On the other hand, when the ratio is increased, a thin line is reproduced with a high density.

In this exemplary embodiment, the thin line means a 1-bit line, and reproducibility of a thin line means formation of a thin line image with a proper toner density.

FIG. 5 is a diagram showing the relation between “the ratio of the developing voltage to the cleaning voltage” and “the thin line density”.

As shown in FIG. 5, when the ratio of the developing voltage to the cleaning voltage is law, a thin line image cannot have sufficient density. In other words, reproducibility of a thin line will be difficult.

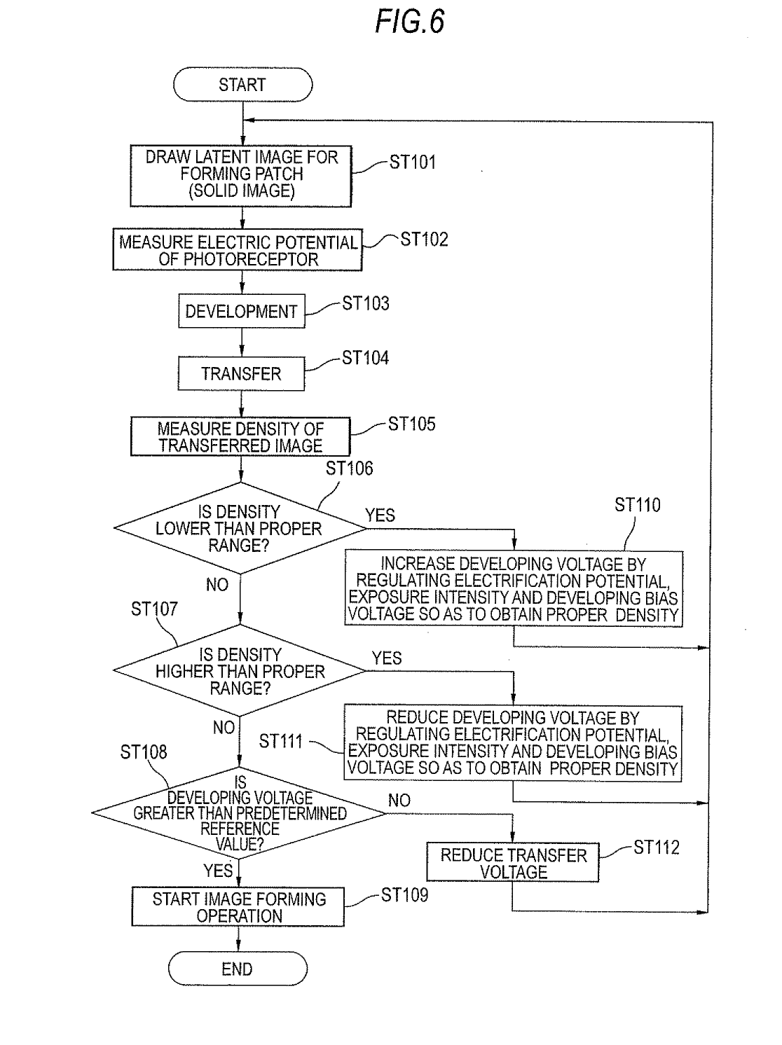

Next, processing of adjusting the image forming conditions in the aforementioned image forming apparatus will be hereinafter described with reference to FIG. 6.

First, the exposure device 3 irradiates the uniformly-electrified photosensitive drum 1 with a laser beam, thereby performing drawing to form a patch (ST101).

The patch is a test image to be formed for measuring the toner density, etc. In this exemplary embodiment, a solid image is formed as the patch.

Subsequently, the surface potential measurement unit 21 measures the surface potentials of the exposed part and the non-exposed part of the photosensitive drum 1, and measurement results are inputted into the control device 27 (ST102). The toner attached to the developing roll 4a transfers to the exposed part in a position opposed to the developing device 4, thereby performing development (ST103). The developed solid image is transferred onto the surface of the intermediate transfer belt 7 (ST104). Then, the toner density detection unit 25 detects the toner density of the solid image formed on the intermediate transfer belt 7, and a detection result is inputted into the control device 27 (ST105).

The toner for forming a patch on the intermediate transfer belt 7 is removed from the intermediate transfer belt 7 by the toner removal device 18 without being secondarily transferred onto a recording sheet.

In the control device 27, it is determined based on the detection result of the toner density detection unit 25 whether the toner density is lower than a proper range or not (ST106). When it is determined that the toner density is not lower than the proper range, it is subsequently determined whether the toner density is higher than the proper range or not (ST107). When it is determined that the toner density is not higher than the proper range, it is found that transfer is executed in the proper toner density range.

When it is determined that the transferred image has the proper density, it is subsequently determined that the developing voltage is greater than a predetermined reference value (ST108). When it is determined that the developing voltage is greater than the reference value, the density adjusting operation is completed and the operation of forming an image on a recording sheet or the like is started (ST109).

In this exemplary embodiment, the reference value of the developing voltage is set to 120V. Therefore, it is determined whether or not the developing voltage is greater than 120V in ST108.

On the other hand, when it is determined that the toner density of the solid image transferred onto the intermediate transfer belt 7 is lower than the proper density (ST106), the control device 27 adjusts at least one of the electrification potential, the exposure intensity and the electric potential of the developing roll 4a in order to set the toner density within the proper range. Accordingly, the developing voltage is increased (ST110). Thus, after the developing voltage is increased, the drawing based on the exposure device 3 for forming the patch (ST101), the measurement of the electric potential on the surface of the photosensitive drum 1 (ST102), the development (ST103), the transfer onto the intermediate transfer belt 7 (ST104) and the measurement of the toner density (ST105) are executed again, and it is determined whether or not the toner density is lower than the proper range (ST106). On the other hand, when it is determined that the toner density is higher than the proper range (ST107), the developing voltage is reduced by adjusting at least one of the electrification potential, the exposure intensity, and the electric potential of the developing roll 4a in order to set the toner density within the proper range (ST111). Then, the patch drawing, the development, the transfer and the measurement of the toner density are sequentially executed again, and it is confirmed that the toner density is in the proper range.

Next, it is determined whether or not the developing voltage is greater than the reference value (i.e., 120V) (ST108). When it is determined that the developing voltage is less than the reference value of 120V, the transfer voltage to be applied to the primary transfer roll 8 is reduced (ST112) and the transfer efficiency is reduced. Subsequently, a patch is formed again on the photosensitive drum 1 (ST101), and the aforementioned steps for adjusting the density of the solid image are performed. When it is then determined that the density of the solid image is in the proper range and the developing voltage is greater than 120V, the density adjusting operation can be completed and the image forming operation can be started.

In general, when the developing voltage is less than the reference value 120V, the uneven density occurs in a solid image and the solid image is deteriorated. Additionally, the ratio of the developing voltage to the cleaning voltage is reduced in conjunction with the reduction of the developing voltage. Reproducibility of the thin line is accordingly deteriorated. When the electric potential of the non-exposed part is reduced to maintain fine reproducibility of the thin line, the cleaning voltage is reduced and fog easily occurs.

According to this exemplary embodiment, on the other hand, the transfer efficiency is reduced when the developing voltage is less than the reference value. Therefore, the proper density is achieved for a solid image without setting the developing voltage to be less than the reference value. Consequently, even when the developing density is excessively increased, the density of the solid image is properly adjusted and thus proper reproduction of a thin line and inhibition of fog can be easily performed.

When the electrification amount of toner is reduced in a highly-humid condition or the like, the developing density is increased. Accordingly, the developing voltage is required to be adjusted to a low value. According to this exemplary embodiment, however, an adjustable range of the image forming conditions is extended so that a fine image can be formed irrespective of variation of a factor which affects the image density, such as the circumstances.

In this exemplary embodiment, the reference value of the developing voltage is set to 120V. However, the reference value can be arbitrarily set in accordance with the developing efficiency, the transfer efficiency or the like of the image forming apparatus.

Next, an image forming apparatus of a second exemplary embodiment according to the present invention will be hereunder described.

The construction of the image forming apparatus is basically the same as that of the image forming apparatus of the first exemplary embodiment illustrated in FIG. 1 except for the control device. Additionally, the image forming operation of this exemplary embodiment is the same as that of the first exemplary embodiment. Therefore, the description of the construction and the operation of the image forming apparatus of this exemplary embodiment will be omitted from the following description, and the control of the image forming conditions will be hereunder described.

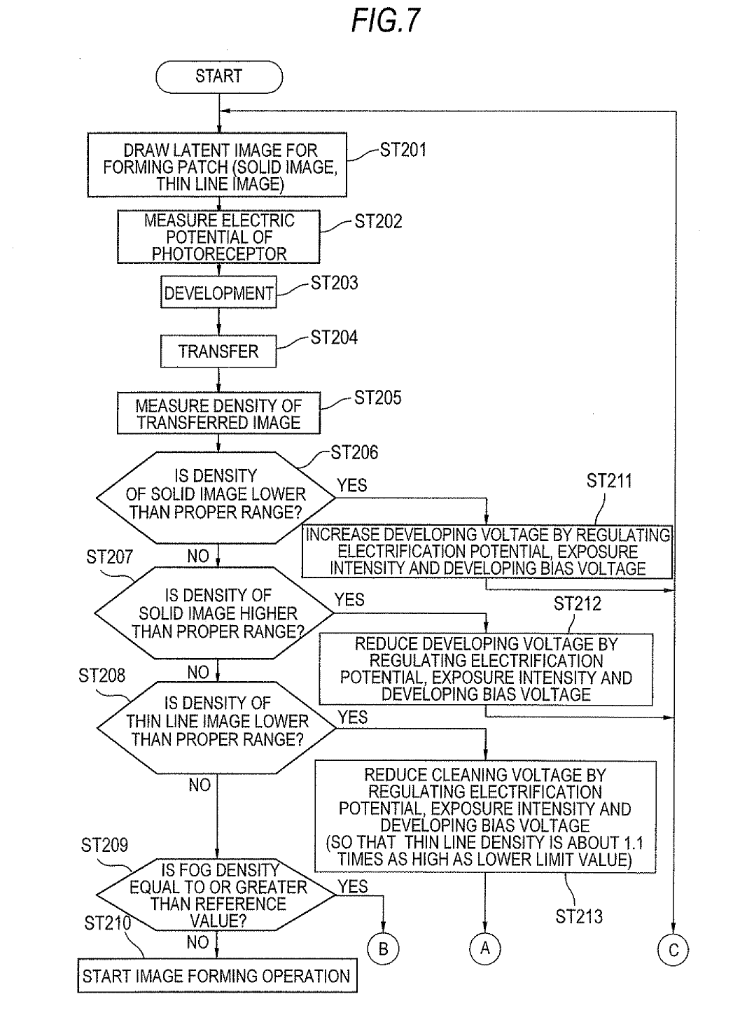

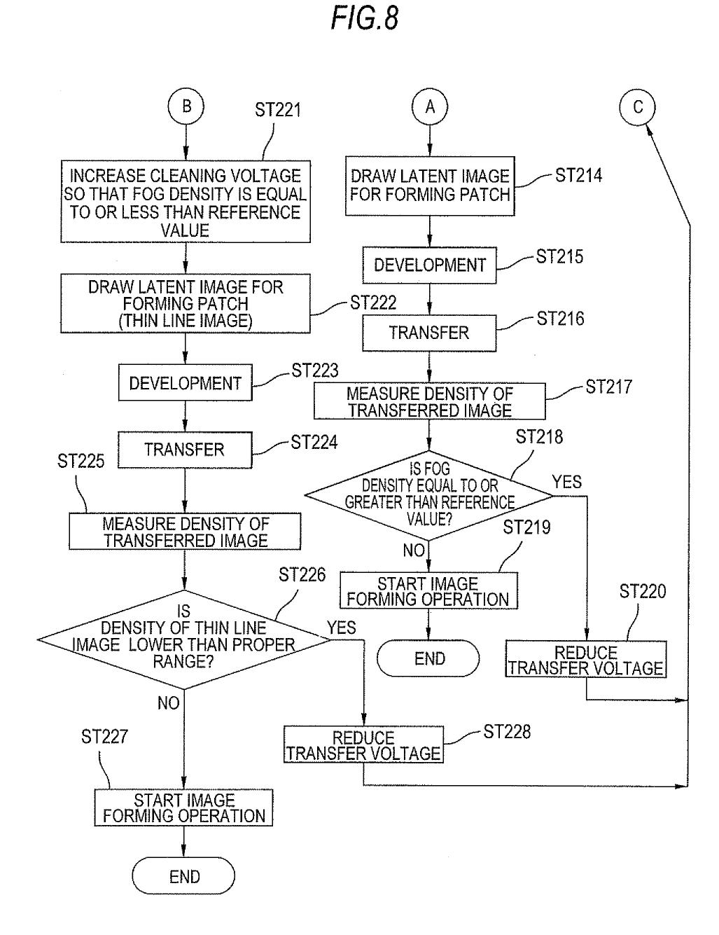

The control to be executed in this exemplary embodiment relates to the adjustment of the image forming conditions based on the data obtained from a patch of a solid image and a patch of a thin line image, and will be hereunder described with reference to flowcharts of FIGS. 7 and 8.

In the image forming apparatus, the exposure device 3 irradiates the photosensitive drum 1 for forming a patch of a solid image and a patch of a thin line image with image light (ST201). Then, similar to the controls illustrated in FIG. 6, the surface potential measurement unit 21 measures the surface potential of the photosensitive drum 1 and a measurement result is transmitted to the control device 27 (ST202). Latent images for forming patches are developed by the transfer of toner (ST203). The patch is transferred onto the surface of the intermediate transfer belt 7 (ST204). Subsequently, the toner density detection unit 25 detects the toner density of the image formed on the intermediate transfer belt 7 and the density of the non-image part. The detection results are inputted into the control device 27 (ST205).

Based on the detection results, it is determined whether or not the toner density of the solid image is lower than a proper range (ST206) and whether or not the toner density of the solid image is higher than the proper range (ST207). When it is determined that the toner density of the solid image is lower than the proper range, the developing voltage is increased by adjusting at least one of the electrification potential, the exposure intensity and the electric potential of the developing roll 4a (ST211). On the other hand, when it is determined that the toner density of the solid image is higher than the proper range, the developing voltage is reduced by executing the aforementioned adjustment (ST212).

When the aforementioned adjustment is executed so that the solid image has the toner density within the proper range, it is subsequently determined whether or not the toner density of the thin line image is lower than the proper range (ST208). When it is determined that the toner density of the thin line image is not lower than the proper range, it is determined whether or not the fog density is equal to or greater than a reference value (ST209). When it is determined that the fog density is less than the reference value, the thin line is properly reproduced and fog is properly inhibited. Accordingly, the adjustment of the image forming conditions is completed, and the operation of forming an image on a recording sheet is started (ST210).

In this exemplary embodiment, the density of the 1-bit thin line is represented by a status A density value, and the lower limit thereof is set to 0.35. On the other hand, the fog density is likewise represented by the status A density value, and an allowable upper limit thereof is set to 0.05. In ST208, it is therefore determined whether or not the toner density of the thin line image is lower than the proper range (0.35) (ST208). When it is determined that the toner density of the thin line image is not lower than 0.35, it is determined whether or not the toner density of fog is equal to or greater than the reference value 0.05 (ST209).

When it is determined that the toner density of the thin line image is lower than the proper range 0.35 (ST208), the cleaning voltage is reduced so as to increase the thin line density by adjusting at least one of the electrification potential, the exposure intensity and the electric potential of the developing roll 4a (ST213). In this case, the relation between “the ratio of the developing voltage to the cleaning voltage” and “the thin line density” can be estimated based on an experiment or the like in advance. For example, the aforementioned adjustment is executed so that the thin line density is about 1.1 time as dense as the lower limit value.

Subsequently, patches are formed again (ST214), and the development (ST215), the transfer (ST216) and the measurement of the toner density of the transfer image (ST217) are executed. Furthermore, it is determined whether or not the fog density is equal to or greater than the reference value (i.e., 0.05) (ST218). When it is determined that the fog density is not equal to or greater than the reference value, the control of the image forming conditions are completed and the image forming operation is started (ST219).

However, when it is determined that the fog density is equal to or greater than the reference value in ST218, reproducibility of the thin line and inhibition of fog are not simultaneously achieved. Therefore, the transfer voltage to be applied to the primary transfer roll 8 is reduced, and the transfer efficiency is controlled to be reduced (ST220).

Patches are drawn again on the photosensitive drum under the state that the transfer efficiency is reduced (ST201), and the density adjustment of the solid image (ST206, ST211, ST207 and ST212) is performed again in accordance with the aforementioned flow. In this case, the developing voltage to make the solid image have a proper density is increased to be higher than that before the transfer efficiency is changed. Therefore, under this condition, the density of the thin line image is properly reproduced with high probability. Accordingly, when it is determined that the thin line image of proper density is reproduced (ST208), it is then determined whether or not the fog density is equal to or greater than the reference value (ST209). When it is further determined that fog is properly inhibited, the adjustment of the image forming conditions are completed (ST210).

On the other hand, when it is determined that the fog density is equal to or greater than the reference value although the density of the thin line is properly reproduced (ST209), the control device 27 increases the cleaning voltage so that the fog density is set to be equal to or less than 0.05 (ST221). When the cleaning voltage is increased, the ratio of the developing voltage to the cleaning voltage is reduced. Accordingly, reproducibility of the thin line may be deteriorated. Therefore, patches are drawn again (ST222), and the development (ST223), the transfer (ST224) and the measurement of toner density of the transferred image (ST225) are executed. Furthermore, it is determined whether or not the toner density of the thin line image is lower than the proper range 0.35 (ST226). When it is determined that the toner density of the thin line image is not lower than the proper range, the adjustment of the image forming conditions is completed (ST227).

However, when it is determined that the toner density of the thin line image is lower than the proper range 0.35 in ST226 (ST226), the transfer voltage is reduced, and the transfer efficiency is accordingly reduced (ST228). This is because reproducibility of the thin line and inhibition of fog are not simultaneously achieved. Thus, the developing voltage can be increased by reducing the transfer efficiency. Therefore, when the adjustment of the image forming conditions is performed again to properly set the solid image density after formation of patches (ST201), the adjustable range of values of “the ratio of the developing voltage to the cleaning voltage” and “the cleaning voltage” are extended. Reproducibility of the thin line and inhibition of fog can be thereby achieved simultaneously. When it is then determined that reproducibility of the thin line and inhibition of fog are properly executed (ST208, ST209), the control of the image forming conditions is completed and the operation of forming an image on a recording sheet is started (ST210).

In the control, it is difficult to simultaneously achieve reproducibility of the thin line image and inhibition of fog when the developing voltage is reduced in the adjustment of the solid image density. However, the developing voltage can be increased by reducing the transfer efficiency. Reproducibility of the thin line and inhibition of fog are thereby simultaneously achieved. Consequently, the solid image and the thin line image can be formed with proper density, and the fog density can be inhibited.

In the control of this exemplary embodiment, the reference value of the density of the 1-bit thin line image is represented by the status A density value and it is set to 0.35. The allowable upper limit of the toner density of fog is also represented by the status A density value, and it is set to be equal to or less than 0.05. However, these values can be set to be any suitable values.

Next, an image forming apparatus of a third exemplary embodiment according to the present invention will be hereunder described.

Except for the control device, the construction of the image forming apparatus of this exemplary embodiment is basically the same as that of the image forming apparatus of the first exemplary embodiment as illustrated in FIG. 1. Additionally, the operation of forming an image in the image forming apparatus of this exemplary embodiment is the same as that in the image forming apparatus of the first exemplary embodiment. Therefore, the construction and the operation of the image forming apparatus will be omitted from the following description, and the control of the image forming conditions will be described.

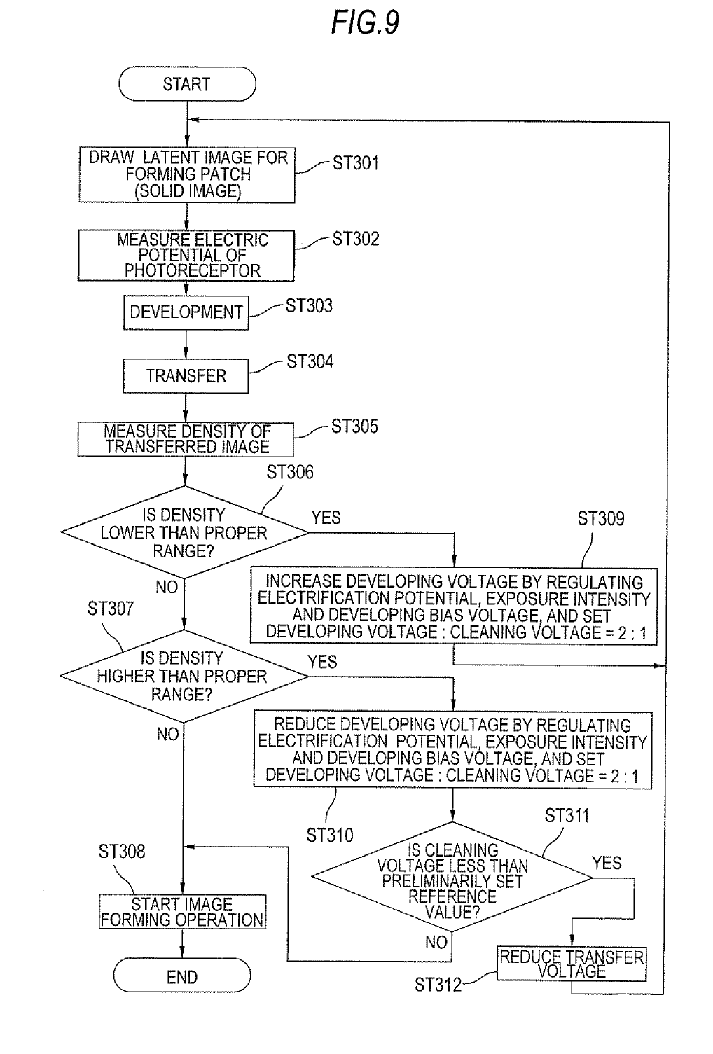

As illustrated in a flowchart of FIG. 9, the control of the image forming conditions in the image forming apparatus is executed so as to establish the following relation “the developing voltage:the cleaning voltage=2:1”.

In response to the start of the operation of controlling the image forming conditions, a patch of a solid image is drawn on the photosensitive drum 1 (ST301) and the surface potential measurement unit 21 measures the surface potential of the photosensitive drum 1 (ST302). Subsequently, the patch is developed (ST303), and the transfer of the developed patch onto the intermediate transfer belt 7 (ST304) and the measurement of the toner density of the transferred image by the toner density detection unit 25 (ST305) are executed. Furthermore, it is determined whether or not the toner density is lower than a proper range (ST306). When it is determined that the toner density is not lower than the proper range, it is then determined whether or not the toner density is higher than the proper range (ST307). When it is determined that the toner density is not higher than the proper range, this means that the patch is formed with a density in the proper range. Accordingly, the operation of forming an image to be fixed on a recording sheet is started (ST308).

The initial setting of the ratio of the developing voltage to the cleaning voltage is set to about 2:1. Therefore, the thin line is reproduced under a fine condition. Furthermore, fog is also properly inhibited with the initially set voltages (i.e., the developing voltage and the cleaning voltage).

On the other hand, when it is determined that the toner density of the transferred image is lower than the proper range, the developing voltage is increased by adjusting at least one of the electrification potential, the exposure intensity and the electric potential of the developing roll 4a. Simultaneously, the ratio of the increased developing voltage to the cleaning voltage is adjusted to the preset ratio (i.e., 2:1) (ST309).

After the ratio of the developing voltage to the cleaning voltage is thus set to 2:1, a patch is drawn again (ST301). Then, the development (ST303), the transfer (ST304) and the measurement of density (ST305) are executed. Accordingly, the solid image density is adjusted.

On the other hand, when it is determined that the toner density is higher than the proper range, the developing voltage is reduced and the electrification potential, the exposure intensity and the electric potential of the developing roll 4a are adjusted so that the ratio of the reduced developing voltage to the cleaning voltage is set to 2:1 (ST310). Then, it is determined whether or not the cleaning voltage is less than a preset reference value in order to determine whether or not the fog density is properly inhibited (ST311).

In this exemplary embodiment, the reference value of the cleaning voltage for preventing fog is set to 80V. Therefore, it is determined whether or not the cleaning voltage is less than 80V in ST311. When it is determined that the cleaning voltage is equal to or greater than 80V, it is possible to determine that occurrence of fog is inhibited. Accordingly, the image forming operation is started (ST308).

On the other hand, when it is determined that the cleaning voltage is less than the reference value (i.e., 80V) in ST311, fog may occur. Therefore, the transfer efficiency is reduced by reducing the transfer voltage (ST312). Under this condition, the solid image density is adjusted again. At this time, the transfer efficiency is reduced, and thus the developing voltage when the solid image has a proper density can be set to a high value. Furthermore, the ratio of the developing voltage to the cleaning voltage is set to a predetermined value, and the cleaning voltage is set to a high value, so that occurrence of fog is inhibited.

In the aforementioned image forming apparatus, the solid image density and reproducibility of the thin line are thus properly adjusted. When these adjustments and inhibition of fog are not simultaneously achieved, the transfer efficiency is reduced. With this construction, the image forming conditions can be adjusted to simultaneously achieve the solid image density, reproducibility of the thin line, and inhibition of fog.

The control of this exemplary embodiment is executed to implement fine reproducibility of the thin line image by setting the ratio of the developing voltage to the cleaning voltage to 2:1. However, the ratio of the developing voltage to the cleaning voltage can be arbitrarily set to the extent that the thin line is reproduced in a good condition.

Next, an image forming apparatus of a fourth exemplary embodiment according to the present invention will be hereunder described.

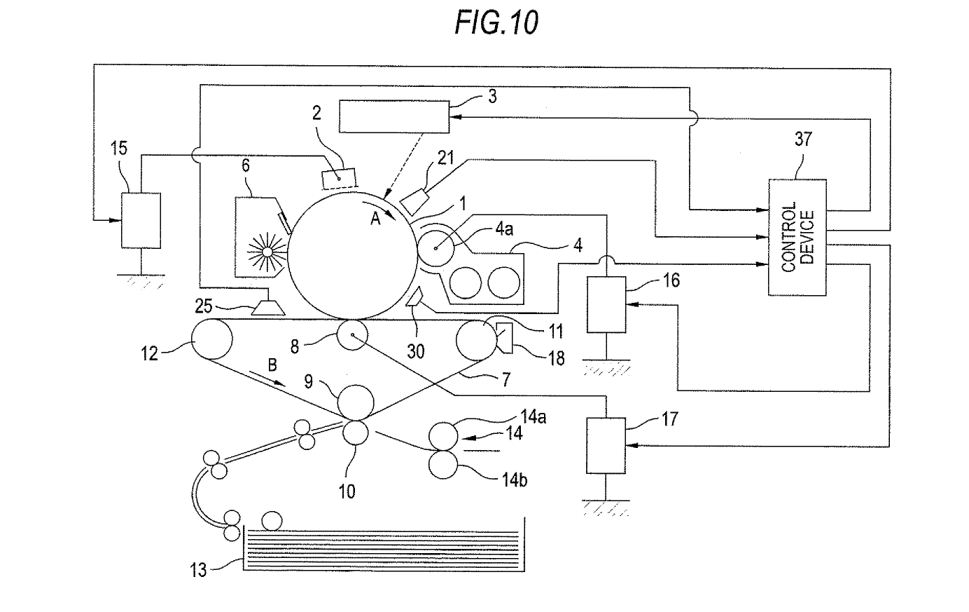

FIG. 10 is a schematic diagram showing the image forming apparatus of the fourth exemplary embodiment.

The image forming apparatus of this exemplary embodiment is provided with a toner amount detection unit 30 for measuring the amount of toner transferred onto the photosensitive drum 1, in addition to the construction of the image forming apparatus of the first exemplary embodiment illustrated in FIG. 1. The toner amount detection unit 30 is disposed at the downstream side of the developing device 4 in the moving direction of the circumferential surface of the photosensitive drum 1 while it is disposed at the upstream side of the primary transfer roll 8. The toner amount detection unit 30 is also opposed to the photosensitive drum 1. The toner amount detection unit 30 detects the density of the toner transferred onto the surface of the photosensitive drum 1, and inputs a detection result into a control device 37. The control device 37 is configured to function as a charge amount estimation unit for estimating the amount of electrostatic charges of toner based on the detection value of the toner amount detection unit 30 and the developing voltage.

The construction of the image forming apparatus of this exemplary embodiment is achieved by providing the construction of the image forming apparatus of the first exemplary embodiment with the toner amount detection unit 30, and the control device 37 is provided with the function as the charge amount estimation unit. Therefore, identical reference numerals are assigned to identical components, and the description thereof is omitted from the following description.

The toner amount detection unit 30 is opposed to the surface of the photosensitive drum 1 without coming into contact with it. The toner amount detection unit 30 measures the amount of toner developed on the photosensitive drum 1 based on reflectance of light. In this exemplary embodiment, a mirror-reflection type DMA sensor (developed mass per area sensor) is adopted as the toner amount detection unit 30. The DMA sensor detects variation of a rate at which mirror-reflection light from the photosensitive drum 1 is blocked by the toner.

The toner amount detection unit 30 is not limited to the aforementioned sensor, and any other well-known sensor can be used as the toner amount detection unit 30.

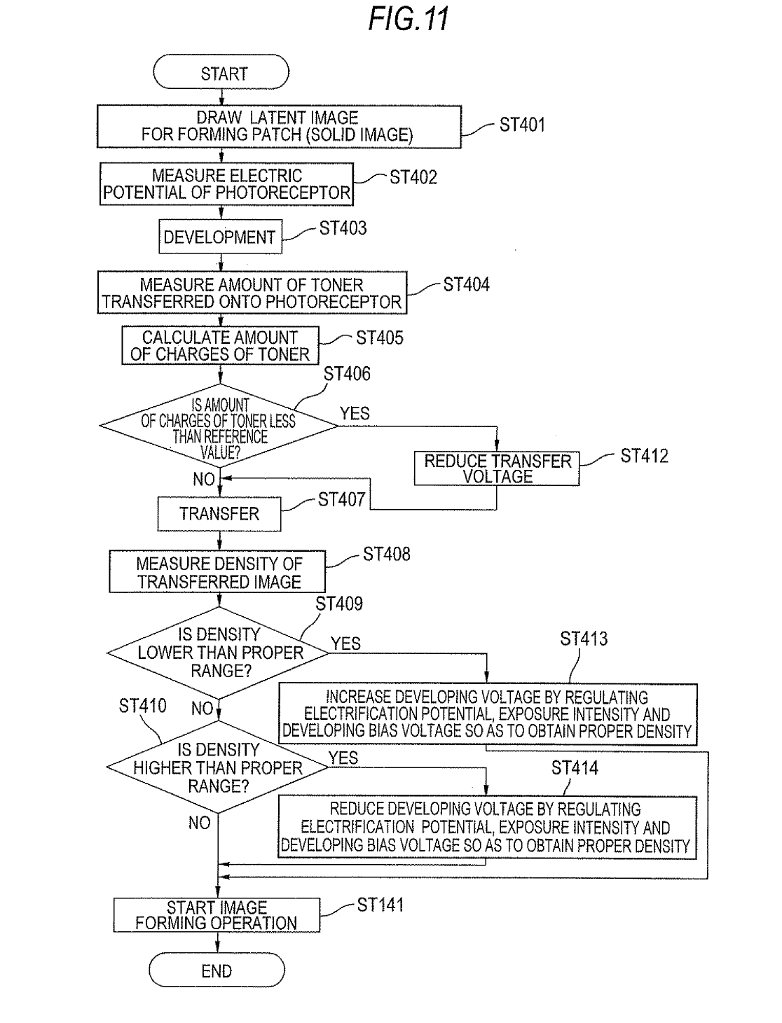

FIG. 11 is a flowchart showing the control of the image forming conditions in the aforementioned image forming apparatus.

When the controlling operation is started, a patch for forming a solid image is drawn on the photosensitive drum 1 (ST401), and the electric potential on the photosensitive drum is measured (ST402). Then, the patch is developed and a toner image of the solid image is formed on the photosensitive drum 1 (ST403). The toner amount detection unit 30 measures the amount of toner of the toner image on the photosensitive drum 1, and a measurement result is inputted into the control device 37. As a function of the charge amount estimation unit, the control device 37 computes the amount of charges of toner based on a detection result of the toner amount detection unit 30 and a measurement result of the surface potential measurement unit 21, and the amount of electrostatic charges of toner is estimated (ST405).

It is determined whether or not the amount of charges of toner is less than a preset reference value based on the estimation value (ST406). When it is determined that the amount of charges of toner is equal to or greater than the reference value, the toner density detection unit 25 detects the density of the toner image (ST408), which is transferred onto the intermediate transfer belt 7 (ST407). It is then determined whether or not the toner density is lower than a proper range (ST409).

On the other hand, when it is determined that the amount of charges of toner is lower than the reference value, the transfer voltage is reduced (ST412). Furthermore, the transfer of the patch (ST407), the measurement of density of the transfer image (ST408) and the estimation of density of the solid image (ST409) are likewise executed under a condition that the transfer efficiency is reduced. When it is determined that the density of the solid image is lower than the proper range, any one or some of the electrification voltage on the surface of the photosensitive drum 1, the exposure amount and the electric potential to be applied to the developing roll 4a are adjusted so as to increase the developing voltage (ST413). When it is determined that the solid image density is higher than the proper range (ST410), the developing voltage is reduced so as to set the toner density in the proper range by likewise adjusting any one or some of the electrification voltage on the surface of the photosensitive drum 1, the exposure amount, and the electric potential to be applied to the developing roll 4a (ST414). Consequently, the solid image density is properly set, and the control of the image forming conditions is completed. Then, the operation of forming an image to be transferred onto a recording sheet is started (ST411).

In the adjustment of the solid image density, the developing density is generally increased when the amount of electrostatic charges of toner is reduced. In other words, reduction in the amount of electrostatic charges of toner causes transfer of the large amount of toner until intensity of electric field generated between the exposed part on the photosensitive drum and the developing roll is reduced to the extent that transfer of toner does not occur any more. Therefore, the developing voltage is set to be low so that the density of the solid image is properly set. However, it is not required that the developing voltage is controlled to be excessively low because the transfer efficiency is reduced. Accordingly, the ratio of the developing voltage to the cleaning voltage and the value of the cleaning voltage can be set to be large to the extent that reproducibility of the thin line and inhibition of fog are respectively executed in allowable ranges.

In this exemplary embodiment, the reference value of the amount of electrostatic charges of toner is set to 18 μC/g. When the amount of electrostatic charges of toner, which is estimated by computation, is less than 18 μC/g, the transfer voltage is set to be reduced.

In the aforementioned exemplary embodiments, the toner density detection unit 25 measures the toner density of the patch transferred onto the intermediate transfer belt 7 from the photosensitive drum 1. However, if the apparatus is configured to directly transfer a toner image onto a recording sheet from the photosensitive drum 1, the unit may measure the toner density of the toner image transferred onto the recording sheet. Thus, if the apparatus is not provided with the intermediate transfer belt 7, a transfer voltage/current to be controlled corresponds to a transfer voltage/current to be applied to the transfer device for transferring a toner image formed on the photosensitive drum onto a recording sheet.

What is claimed is:

1. An image forming apparatus, comprising:
an image carrier;
a charging device that charges a surface of the image carrier;
an exposure device that forms an electrostatic latent image on the charged surface of the image carrier;
a developing device that forms a toner image by transferring toner to the electrostatic latent image from a developing member opposed to the image carrier; and
a transfer device that either directly transfers the toner image onto a recording medium or transfers the toner image onto a recording medium after the toner image is temporarily transferred onto an intermediate transfer member,
wherein absolute value of transfer current or absolute value of a transfer voltage to be applied to the transfer device is changed so as to reduce a transfer efficiency when at least one of a developing voltage, a voltage of background and the amount of electrostatic charges of the toner does not satisfy a reference value, the developing voltage being set as a difference between electric potential of the developing member and electric potential of an image part of the electrostatic latent image formed on the image carrier, and the voltage of background being set as a difference between electric potential of the developing member and electric potential of a non-image part on the image carrier.

2. The image forming apparatus according to claim 1, further comprising:
a toner density detection unit that detects a density of the toner image transferred onto the recording medium or the intermediate transfer member; and
an adjusting unit that adjusts the developing voltage based on a result of detection by the toner density detection unit,
wherein the absolute value of the transfer current or the absolute value of the transfer voltage to be applied to the transfer device is changed so as to reduce the transfer efficiency when the developing voltage adjustedbythe adjusting unit is less than a lower limit value.

3. The image forming apparatus according to claim 1, further comprising:
a toner density detection unit that detects both of a density of a thin line formed as a test image and a density of the toner scattered to the non-image part after transfer is executed by the transfer device; and
an adjusting unit that adjusts the density of the thin line and the density of the toner scattered to the non-image part by adjusting at least one of the amount of electrostatic charges of the image carrier by the charging device, the amount of exposure by the exposure device, and electric potential to be applied to the developing member of the developing device based on a result of detection of the toner density detection unit,
wherein the absolute value of the transfer current or the absolute value of the transfer voltage to be applied to the transfer device is changed so as to reduce the transfer efficiency when any one of the density of the thin line adjusted by the adjusting unit and the density of the toner scattered to the non-image part does not satisfy a preset criterion.

4. The image forming apparatus according to claim 1, further comprising:
a toner density detection unit that detects a density of the toner image transferred onto the recording medium or the intermediate transfer member; and
an adjusting unit that adjusts the toner image to have a proper density by adjusting at least one of the amount of electrostatic charges of the image carrier by the charging device, the amount of exposure by the exposure device, and electric potential to be applied to the developing member of the developing device based on a result of detection by the toner density detection unit,
wherein the adjusting unit sets a ratio of the developing voltage to the voltage of background to a value or to be in a value range, and
the absolute value of the transfer current or the absolute value of the transfer voltage to be applied to the transfer device is changed so as to reduce the transfer efficiency when the voltage of background adjusted by the adjusting unit is less than a lower limit value.

5. The image forming apparatus according to claim 1, further comprising:
a toner amount detection unit that detects the amount of toner of the toner image developed on the image carrier; and
a charge amount estimation unit that estimates the amount of electrostatic charges of the toner in the developing device based on a result of detection by the toner amount detection unit and the developing voltage that is a difference between the electric potential of the developing member and the electric potential of the image part of the toner image,
wherein the absolute value of the transfer current or the absolute value of the transfer voltage to be applied to the transfer device is changed so as to reduce the transfer efficiency when an estimation value of the charge amount estimation unit is less than a reference value.
